(19) United States
(12) Patent Application Publication
(10) Pub. No.: US 2012/0166058 A1
(43) Pub. Date: Jun. 28, 2012

(54) METHOD AND MONITORING DEVICE FOR MONITORING A STARTING MANEUVER OF A MOTOR VEHICLE

(75) Inventor: Markus ARMBRUST, Wonsheim (DE)

(73) Assignee: GM GLOBAL TECHNOLOGY OPERATIONS LLC, Detroit, MI (US)

(21) Appl. No.: 13/337,518

(22) Filed: Dec. 27, 2011

(30) Foreign Application Priority Data
Dec. 28, 2010 (DE) 10 2010 056 389.7

(51) Int. Cl. G08G 1/16; B60K 31/00

(52) U.S. Cl. 701/96; 701/1

(57) ABSTRACT

A method is provided for monitoring a starting maneuver of a motor that includes, but is not limited to determining whether an object is detected by a first sensor of the motor vehicle. The first sensor is preferably an ultrasonic sensor that detects objects within a first detection area. The first detection area includes, but is not limited to a first sub-area of surroundings of the motor vehicle that lies in a driving direction. If an object is detected by the the first sensor, the degree of probability of a collision between the object detected by the first sensor and the motor vehicle in case of a starting maneuver of the motor vehicle is determined. If the determined degree of collision probability exceeds a first predefined threshold value, the starting maneuver of the motor vehicle is at least temporarily interrupted.

### CROSS-REFERENCE TO RELATED APPLICATION

This application claims priority to German Patent Application No. 102010056389.7, filed Dec. 28, 2010, which is incorporated herein by reference in its entirety.

### TECHNICAL FIELD

The technical field relates to a method and a monitoring device for monitoring a starting maneuver of a motor vehicle, a computer program product, and a machine-readable medium.

### BACKGROUND

DE 199 34 670 B4 discloses an object detection system, particularly for a motor vehicle, wherein the object detection system consists of a combination of at least three object detectors that respectively have a different detection area and/or a different detection range. The detection areas essentially lie in front of the motor vehicle referred to the driving direction, wherein the detection areas lying in the driving direction overlap one another. The measured value delivered by the object detectors from the overlapping detection areas are used for separate evaluations.

In view of the foregoing, it is desirable to have a method and a monitoring device for monitoring a starting maneuver of a motor vehicle, a computer program product, and a machine-readable medium are also provided that make it possible to increase the safety of an imminent starting maneuver of a motor vehicle. In addition, other objects, desirable features, and characteristics will become apparent from the subsequent summary and detailed description, and the appended claims, taken in conjunction with the accompanying drawings and this background.

### SUMMARY

According to a first embodiment, a method for monitoring a starting maneuver of a motor vehicle features the steps described below. It is determined whether at least one object is detected by at least one first sensor of the motor vehicle. The at least one first sensor is realized in the form of an ultrasonic sensor for detecting objects within a first detection area. The first detection area comprises a first sub-area of the motor vehicle surroundings that lies in a driving direction of the motor vehicle to be monitored. If at least one object is detected by the at least one first sensor, the degree of probability of a collision between the at least one object detected by the at least one first sensor and the motor vehicle in case of a starting maneuver of the motor vehicle is determined. If the determined degree of collision probability exceeds a first predefined threshold value, the starting maneuver of the motor vehicle is at least temporarily interrupted.

The method for monitoring a starting maneuver of a motor vehicle according to the above-described embodiment allows an increased safety of an imminent starting maneuver of the motor vehicle in that the at least one first sensor is realized in the form of an ultrasonic sensor. In this respect, the application is based on the notion that ultrasonic sensors are particularly suitable for detecting foreign objects in the vicinity of the motor vehicle. An object detection in the vicinity is of particular importance for the prevention of possible collisions during a starting maneuver because the distance from objects located in the vicinity is particularly small. The method according to the above-described embodiment therefore allows an improved prevention of possible collisions between the motor vehicle and other objects.

In another embodiment, a warning message is furthermore output in case the determined degree of collision probability exceeds the first predefined threshold value. In this case, the warning message may be output in the form of an optical and/or acoustical and/or haptical warning message. The warning message is preferably output within the motor vehicle. In this way, the occupants of the motor vehicle, particularly the driver of the motor vehicle, can be advised of the fact that an increased collision probability has been determined, as well as the associated interruption of the starting maneuver of the motor vehicle. Furthermore, the warning message may be additionally or alternatively output within the surroundings of the motor vehicle, for example, by automatically actuating at least one headlight and/or a horn of the motor vehicle. In this way, other traffic participants located in the vicinity of the motor vehicle can also be warned. It would be possible, for example, to warn a pedestrian or a bicyclist who is located in the immediate vicinity of the motor vehicle and represents the object detected by the at least one ultrasonic sensor.

An embodiment of the method includes, but is not necessarily limited to the steps described below. It is determined whether at least one object is detected by at least one second sensor of the motor vehicle. The at least one second sensor is realized in the form of an electromagnetic sensor for detecting objects within a second detection area. The second detection area comprises a second sub-area of the motor vehicle surroundings that lies in the driving direction of the motor vehicle to be monitored and at least partially differs from the first detection area. If at least one object is detected by the at least one second sensor, the degree of probability of a collision between the at least one object detected by the at least one second sensor and the motor vehicle in case of a starting maneuver of the motor vehicle is determined If the determined degree of collision probability exceeds a second predefined threshold value, the starting maneuver of the motor vehicle is at least temporarily interrupted.

The embodiment described above advantageously makes it possible to detect objects that are located in the vicinity of the motor vehicle and outside the first detection area of the ultrasonic sensor by means of the at least one second sensor. This embodiment furthermore makes it possible to merge and to make the aforementioned data mutually plausible such that the accuracy in detecting the instantaneous ambient situation can be advantageously further improved. In this way, the safety of an imminent starting maneuver of the motor vehicle can be further increased. Since a second sensor in the form of an electromagnetic sensor is provided, it is possible, in particular, to already detect objects that are located farther from the motor vehicle at an early stage. The second predefined threshold value may correspond to or be chosen different from the first predefined threshold value. The second predefined threshold value may, in particular, be greater than the first predefined threshold value.

It would be possible to determine whether at least one object is detected by the at least one second sensor of the motor vehicle prior to determining whether at least one object is detected by the at least one first sensor of the motor vehicle. It can be determined whether at least one object is detected by the at least one first sensor of the motor vehicle, in particular, if no object is detected by the at least one second sensor or if the determined degree of collision probability does not exceed the second predefined threshold value. In this way, a required communication bandwidth for the data or measured values acquired by means of the above-described sensors can be advantageously reduced.

The at least one second sensor is preferably selected from the group consisting of a radar sensor, a lidar sensor and an optical camera. Said sensors are exceedingly provided in motor vehicles such that the number of additional components required for the method can be reduced.

In another embodiment, the at least temporary interruption of the starting maneuver can be canceled by an occupant of the motor vehicle, particularly by the driver of the motor vehicle. In this way, the occupant of the motor vehicle can decide whether he would like to continue the starting maneuver of the motor vehicle. In this case, the at least temporary interruption of the starting maneuver preferably can be canceled by actuating the accelerator pedal of the motor vehicle and/or a control element of the motor vehicle provided for this purpose.

In another embodiment, the motor vehicle features an adaptive cruise control system and it is determined whether at least one object is detected by the at least one first sensor of the motor vehicle at least after a deceleration of the motor vehicle to a standstill by means of the adaptive cruise control system. Due to the above-described ultrasonic close-range foreign object detection, this embodiment advantageously makes it possible to increase the safety in a fully or partially autonomous stop-and-go driving mode of the motor vehicle.

After a restarting maneuver, the control of a trailing distance from another motor vehicle that was determined as target vehicle for the control of the trailing distance prior to the deceleration can be resumed. In this way, the control of the trailing distance by means of the adaptive cruise control system can also be advantageously continued in a stop-and-go driving mode of the motor vehicle.

In another embodiment, the speed of the motor vehicle is adjusted to a predefined speed by means of the adaptive cruise control system, for example, for a predetermined duration after a restarting maneuver. Due to this measure, the motor vehicle is in a rolling start mode such that the driver of the motor vehicle can decide during the restarting maneuver whether the control of the trailing distance by means of the adaptive cruise control system should be resumed after getting underway.

The application also pertains to a monitoring device for a motor vehicle for monitoring a starting maneuver of the motor vehicle. The monitoring device features at least one first sensor. The at least one first sensor is realized in the form of an ultrasonic sensor for detecting objects within a first detection area. In this case, the first detection area comprises a first sub-area of the vehicle surroundings that lies in a driving direction of the motor vehicle to be monitored. The monitoring device furthermore features a first evaluation device that is designed for determining whether at least one object is detected by the at least one first sensor. The monitoring device also features a second evaluation device that is designed for determining the degree of probability of a collision between at least one object detected by the at least one first sensor and the motor vehicle in case of a starting maneuver of the motor vehicle. The monitoring device furthermore features an interrupting device that is designed for at least temporarily interrupting the starting maneuver of the motor vehicle if the determined degree of collision probability exceeds a first predefined threshold value.

A motor vehicle is provided that features a monitoring device according to the above-described embodiments. The motor vehicle, for example, of a passenger car or a truck. The monitoring device and the motor vehicle according to the application also have the advantages that were already mentioned above in connection with the method according to the application, but are not quoted again at this point in order to avoid repetitions.

A computer program product is provided that, when executed on an arithmetic unit of the motor vehicle, instructs the arithmetic unit to carry out the steps described below. The arithmetic unit is instructed to determine whether at least one object is detected by at least one first sensor of the motor vehicle. The at least one first sensor is realized in the form of an ultrasonic sensor for detecting objects within a first detection area, wherein the first detection area comprises a first sub-area of the motor vehicle surroundings that lies in a driving direction of the motor vehicle to be monitored. If at least one object is detected by the at least one first sensor, the arithmetic unit is instructed to determine the degree of probability of a collision between the at least one object detected by the at least one first sensor and the motor vehicle in case of a starting maneuver of the motor vehicle. If the determined degree of collision probability exceeds a first predefined threshold value, the arithmetic unit is instructed to at least temporarily interrupt the starting maneuver of the motor vehicle.

The application furthermore pertains to a machine-readable medium, on which a computer program product according to the above-described embodiment is stored. The computer program product and the machine-readable medium according to the application also have the advantages that were already mentioned above in connection with the method according to the application, but are not quoted again at this point in order to avoid repetitions.

### BRIEF DESCRIPTION OF THE DRAWINGS

The present invention will hereinafter be described in conjunction with the following drawing figures, wherein like numerals denote like elements, and:

FIG. 1 shows a flow chart of a method for monitoring a starting maneuver of a motor vehicle according to a first embodiment of the application;

FIG. 2 shows a flow chart of a method for monitoring a starting maneuver of a motor vehicle according to a second embodiment of the application;

FIG. 3A and FIG. 3B show an example of a traffic situation, in which the method according to the application can be used; and

FIG. 4 shows a monitoring device of the motor vehicle illustrated in FIG. 3A and FIG. 3B according to an embodiment of the application.

### DETAILED DESCRIPTION

The following detailed description is merely exemplary in nature and is not intended to limit application and uses. Furthermore, there is no intention to be bound by any theory presented in the preceding background or summary or the following detailed description.

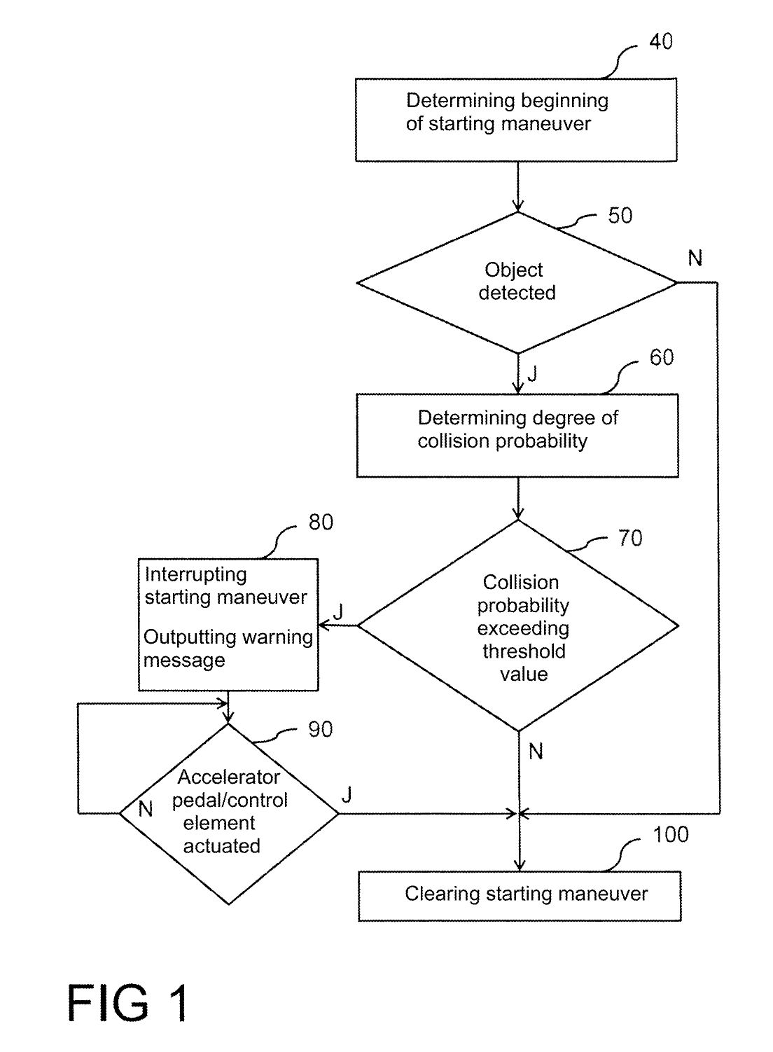

FIG. 1 shows a flow chart of a method for monitoring a starting maneuver of a motor vehicle according to a first embodiment of the application. In this case, the motor vehicle preferably consists of a passenger car. In step 40, a parameter that characterizes the beginning of a starting maneuver of the motor vehicle is determined. The parameter has, for example, of the position of an ignition key of the motor vehicle or the actuation of a start button of the motor vehicle. In this case, the above-mentioned parameters make it possible to determine the beginning of the starting maneuver by detecting the beginning of the process of starting the motor vehicle engine. The starting maneuver may furthermore represent a restarting maneuver of the motor vehicle after it has been decelerated to a standstill. The deceleration may have been realized, in particular, by means of an adaptive cruise control system of the motor vehicle. In the latter instance, the motor vehicle therefore is in a stop-and-go driving mode.

After determining the beginning of the starting maneuver, it is determined in step 50 whether at least one object is detected by at least one first sensor of the motor vehicle. The at least one first sensor is realized in the form of an ultrasonic sensor for detecting objects within a first detection area. In this case, the first detection area comprises a first sub-area of the motor vehicle surroundings that lies in a driving direction of the motor vehicle to be monitored. The driving direction of the motor vehicle to be monitored can be determined, for example, by identifying the currently engaged gear of the motor vehicle. If a forward gear of the motor vehicle is engaged, for example, ultrasonic sensors located in a front region of the motor vehicle are accordingly selected. If a reverse gear of the motor vehicle is engaged, however, ultrasonic sensors located in a rear region of the motor vehicle are selected. If no object is detected by the at least one sensor, the starting maneuver is cleared in step 100, i.e., the starting maneuver of the motor vehicle is continued. However, if at least one object is detected by the at least one first sensor, the degree of probability of a collision between the at least one detected object and the motor vehicle in case of a starting maneuver of the motor vehicle is determined in step 60.

In step 70, it is checked whether the determined degree of collision probability exceeds a first predefined threshold value. If the first predefined threshold value is not exceeded, the starting maneuver is once again cleared as illustrated in step 100. However, if the determined degree of collision probability exceeds the first predefined threshold value, the starting maneuver of the motor vehicle is at least temporarily interrupted automatically in step 80. The automatic interruption of the starting maneuver may be realized, for example, by interrupting the engine starting process or by actuating the adaptive cruise control system of the motor vehicle accordingly.

In the embodiment shown, a warning message is also output within the motor vehicle in step 80 in order to advise the occupants of the motor vehicle, particularly the driver of the motor vehicle, of the fact that the starting maneuver of the motor vehicle has been automatically interrupted. In this case, the warning message may be output, for example, in the form of an optical and/or acoustical and/or haptical warning message.

In step 90, it is furthermore determined whether an accelerator pedal and/or a control element of the motor vehicle designed for canceling the interruption of the starting maneuver such as, for example, a momentary contact switch is actuated. If neither of said elements is actuated, step 90 is carried out once again. However, if at least one of said elements is actuated, the interruption of the starting maneuver is canceled such that the starting maneuver is cleared as illustrated in step 100.

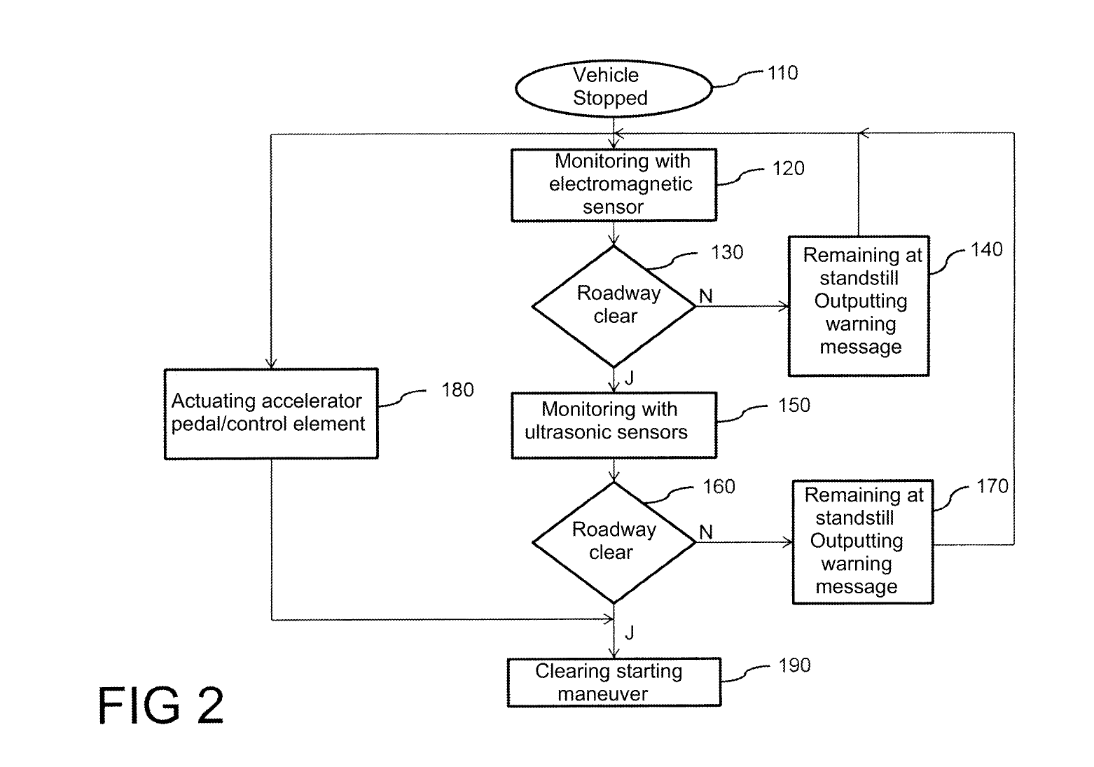

FIG. 2 shows a flow chart of a method for monitoring a starting maneuver of a motor vehicle according to a second embodiment of the application. The motor vehicle once again is preferably a passenger car. In the embodiment of the method shown, the motor vehicle is in a stop-and-go driving mode, i.e., in a fully or partially autonomous driving mode realized with an adaptive cruise control system of the motor vehicle. The stop-and-go driving mode may be activated, for example, when the speed of the motor vehicle falls short of a predefined threshold value such as, for example, 5 km/h or the vehicle is at a standstill after a deceleration. The predefined threshold value may be adjustable, particularly by the driver of the motor vehicle.

If it is determined that the motor vehicle is stopped as illustrated in step 110, at least one electromagnetic sensor monitors a second sub-area of the motor vehicle surroundings that lies in the driving direction of the motor vehicle to be monitored in step 120. For this purpose, the electromagnetic ambient environment sensor has a second detection area that comprises the second sub-area of the motor vehicle surroundings and is realized, for example, in the form of a radar sensor, a lidar sensor, and/or an optical camera.

In step 130, it is determined whether the roadway of the motor vehicle to be traveled is free of obstacles based on data or measured values acquired by the electromagnetic sensor. For this purpose, it is determined whether at least one object is detected by the at least one electromagnetic sensor. If at least one object is detected by the sensor, the degree of probability of a collision between the detected object and the motor vehicle in case of a starting maneuver of the motor vehicle is also determined.

If it is determined in step 130 that the roadway is not clear, i.e., that at least one object is located in the roadway to be traveled and the degree of collision probability exceeds a second predefined threshold value, the starting maneuver of the motor vehicle is at least temporarily interrupted in step 140. The motor vehicle therefore remains at a standstill.

In the embodiment shown, a warning message or a notification is furthermore output for the occupants of the motor vehicle, particularly the driver of the motor vehicle. In this case, the warning message may be output in the form of an optical and/or acoustical and/or haptic warning message. However, if it is determined in step 130 that the roadway is clear, i.e., that no object is detected by the at least one electromagnetic sensor or the determined degree of collision probability does not exceed the second predefined threshold value, at least one ultrasonic sensor begins to monitor a first sub-area of the vehicle surroundings that lies in the driving direction of the motor vehicle to be monitored in step 150. The at least one ultrasonic sensor is designed for detecting objects within a first detection area, wherein the first detection area comprises the first sub-area of the motor vehicle surroundings and at least partially differs from the second detection area. The first detection area comprises, in particular, the vicinity of the motor vehicle. In this case, the monitoring is preferably realized with a plurality of ultrasonic sensors in such a way that the detection areas of the ultrasonic sensors jointly cover the width of the motor vehicle.

In step 160, it is determined whether the roadway of the motor vehicle to be traveled is free of obstacles based on data or measured values acquired by the at least one ultrasonic sensor. For this purpose, it is determined whether at least one object is detected by the at least one ultrasonic sensor. If such an object is detected, the degree of probability of a collision between the detected object and the motor vehicle in case of a starting maneuver of the motor vehicle is also determined. If it is determined in step 160 that the roadway is not clear, i.e., that at least one object is located in the roadway to be traveled and the degree of collision probability exceeds a first predefined threshold value, the starting maneuver of the motor vehicle is at least temporarily interrupted in step 170. The motor vehicle therefore remains at a standstill. In the embodiment shown, a warning message such as, for example, an optical and/or acoustical and/or haptical warning message is also output for the occupants of the motor vehicle, particularly the driver of the motor vehicle, in step 170. However, if it is determined in step 160 that the roadway is clear, i.e., that no object is detected by the at least one ultrasonic sensor or the determined degree of collision probability does not exceed the first predefined threshold value, the starting maneuver is cleared in step 190, i.e., the starting maneuver of the motor vehicle is continued.

If the starting maneuver of the motor vehicle has been interrupted as illustrated in steps 140 and 170, it is furthermore determined whether an accelerator pedal and/or a control element for canceling the interruption of the starting maneuver is actuated. If this is the case as illustrated in step 180 of the embodiment shown, the starting maneuver is once again cleared as illustrated in step 190. After the starting maneuver has been cleared, i.e., during a restarting maneuver of the motor vehicle in the stop-and-go driving mode, it is possible to resume the control of a trailing distance from another motor vehicle that was determined as target vehicle for the control of the trailing distance prior to the deceleration. It is furthermore possible to adjust the speed of the motor vehicle to a predefined speed by means of the adaptive cruise control system after a restarting maneuver and therefore to realize a rolling start mode for the motor vehicle.

In the embodiment shown, ultrasonic sensors used, for example, by the parking assist system are activated in the stop-and-go driving mode in order to scan the vicinity in front of the motor vehicle, particularly for low foreign objects. When foreign objects are detected by the ultrasonic parking assist system, the fully or partially autonomous starting maneuver is inhibited and a starting maneuver only becomes possible after a corresponding confirmation by the driver with the aid of a suitable sensor such as, for example, a momentary contact switch and/or the accelerator pedal. This is based on the notion that electromagnetic ambient environment sensors in the form of an optical camera and/or a radar sensor are designed for detecting objects within a typical range of up to approximately 200 meters and with a relatively small angular aperture that is also referred to as Field Of View (FOV). Consequently, objects that are located very close to the motor vehicle can only be detected inadequately or not at all. The ultrasonic close-range foreign object detection shown and the associated intervention in the autonomous or partially autonomous clearance of the starting maneuver can solve this problem and therefore prevent accidents and injuries in the fully or partially autonomous stop-and-go driving mode.

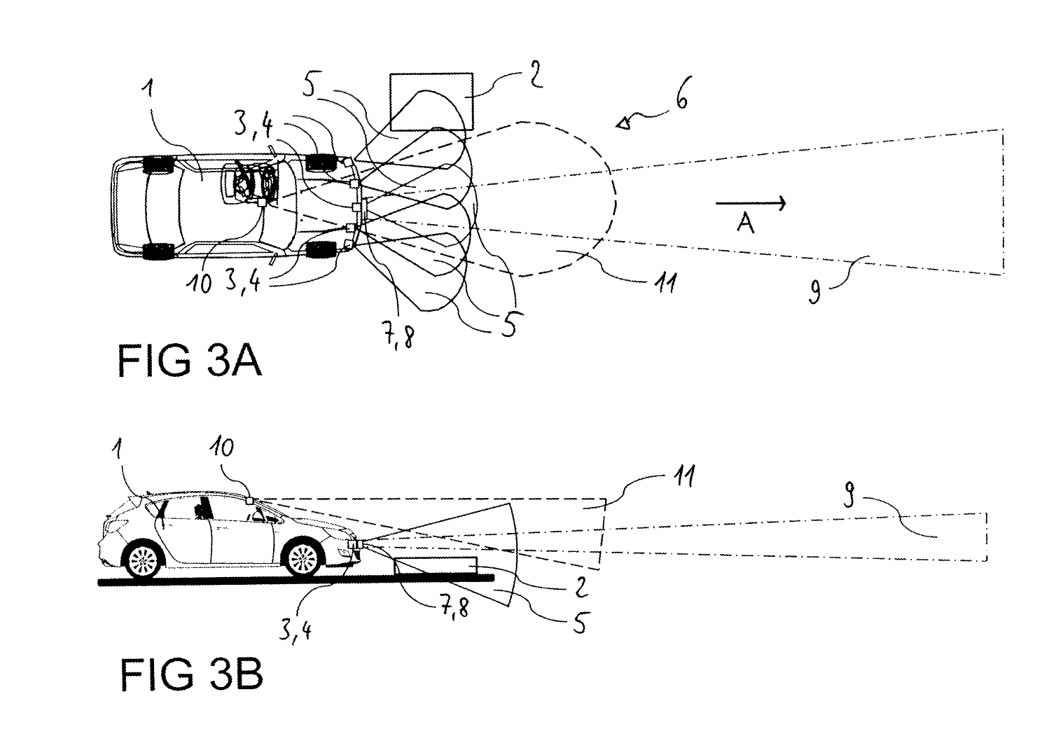

FIG. 3A and FIG. 3B show an example of a traffic situation, in which the methods according to the embodiments of the application, particularly the methods according to the embodiments illustrated in FIG. 1 and FIG. 2 can be used. In this respect, FIG. 3A shows a schematic top view of a motor vehicle 1 and FIG. 3B shows a schematic side view of the motor vehicle 1.

The motor vehicle 1 in this example is a passenger car and features first sensors 3 in the form of ultrasonic sensors 4, as well as a second sensor 7 in the form of an electromagnetic sensor 8 that consists of a radar sensor in the embodiment shown. The motor vehicle 1 in the embodiment shown also features another electromagnetic sensor 10 in the form of an optical camera. The ultrasonic sensors 4 respectively have detection areas 5 that are schematically illustrated with a continuous line. In this case, the detection areas 5 are arranged in such a way that they partially overlap in the surroundings 6 of the motor vehicle 1, cover the width of the motor vehicle 1 in the vicinity thereof and extend beyond the motor vehicle 1 in the lateral direction of the vehicle. The detection areas 5 cover the vicinity of the motor vehicle 1, for example, within a range of up to six meters in a driving direction of the motor vehicle 1 to be monitored that is schematically indicated with an arrow A and respectively have a small angular aperture of typically approximately 20° to approximately 30°. In the embodiment shown, the motor vehicle 1 features five ultrasonic sensors 4.

The sensor 7 in the form of a radar sensor has a detection area 9 that is schematically illustrated with a dot-dash line and the sensor 10 in the form of an optical camera has a detection area 11 that is schematically illustrated with a broken line, wherein these detection areas extend father in the longitudinal direction of the vehicle and therefore in the driving direction to be monitored than the detection areas 5. The detection area 9 partially differs from the detection area 11, as well as from the detection areas 5. Furthermore, the detection area 11 also partially differs from the detection areas 5.

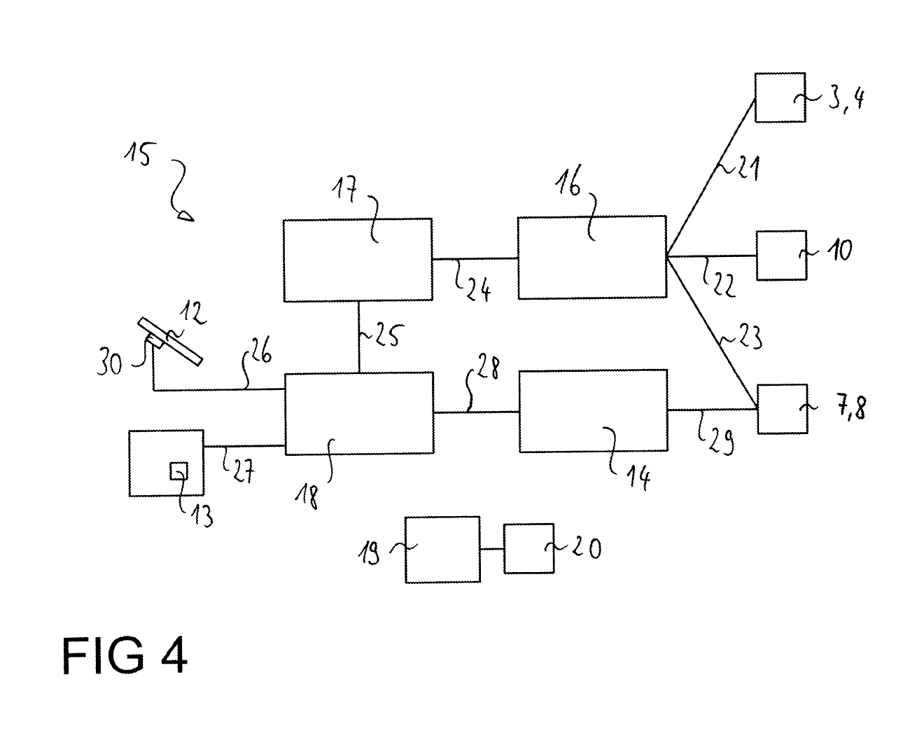

In the traffic situation shown, an object 2 with a small height is located in the vicinity of the motor vehicle 1 in the driving direction to be monitored. According to FIG. 3A and FIG. 3B, the object 2 is located outside the respective detection areas 9 and 11 of the radar sensor and the optical camera. Consequently, the object 2 cannot be detected by said sensors. However, the object 2 is at least partially located within at least one of the detection areas 5 of the ultrasonic sensors 4 and therefore can be detected by at least one of the ultrasonic sensors 4. The degree of probability of a collision between the object 2 and the motor vehicle 1 in case of a starting maneuver of the motor vehicle 1 can be determined based on measured values of this ultrasonic sensor 4 and, for example, based on the distance of the object 2 from the motor vehicle 1 and/or a speed of the object 2. If the determined degree of collision probability exceeds a first predefined threshold value, the starting maneuver of the motor vehicle is at least temporarily interrupted as described in greater detail below in connection with the following figure. To this end, FIG. 4 shows a monitoring device 15 of the motor vehicle illustrated in FIG. 3A and FIG. 3B. Components with the same functions as in said figures are identified by the same reference symbols and not described again below.

The monitoring device 15 features a first evaluation device 16 that is designed for determining whether at least one object is detected by at least one of the ultrasonic sensors 4 and/or the electromagnetic sensor 8 in the form of a radar sensor and/or the additional electromagnetic sensor 10 in the form of an optical camera. For this purpose, the first evaluation device 16 is connected to the ultrasonic sensors 4 via at least one signaling line 21, to the electromagnetic sensor 8 via a signaling line 23 and to the electromagnetic sensor 10 via a signaling line 22.

The monitoring device 15 furthermore features a second evaluation device 17 that is designed for determining the degree of probability of a collision between at least one object detected by the sensors 3, 7 and/or 10 and the motor vehicle in case of a starting maneuver of the motor vehicle. For this purpose, the second evaluation device 17 is connected to the first evaluation device 16 via a signaling line 24.

In addition, the monitoring device 15 features an interrupting device 18 that is designed for at least temporarily interrupting a starting maneuver of the motor vehicle. In this case, the starting maneuver of the motor vehicle is at least temporarily interrupted if the determined degree of collision probability exceeds the respective threshold value, i.e., the first predefined threshold value in case an object is detected by the ultrasonic sensors 4, the second threshold value in case an object is detected by the sensor 7 and a third threshold value in case an object is detected by the sensor 10. Said threshold values may be identical or differ from one another.

In this case, the interrupting device 18 is connected to the second evaluation device 17 via a signaling line 25. The interrupting device 18 is furthermore connected to an adaptive cruise control system 14 of the motor vehicle via a control and signaling line 28. In the embodiment shown, the starting maneuver is at least temporarily interrupted by transmitting a corresponding control signal to the adaptive cruise control system 14. The adaptive cruise control system 14 is also referred to as ACC system (ACC, Adaptive Cruise Control), distance/cruise control system or ADC system (Automatic Distance Control) and furthermore connected to the electromagnetic sensor 8, i.e., to the radar sensor, via a signaling line 29.

The interrupting device 18 is also connected to the sensor 30 designed for determining the degree, by which the accelerator pedal 12 of the motor vehicle is depressed, via a signaling line 26. The interrupting device 18 is furthermore connected to a control element 13 for canceling the interruption via a signaling line 27. The automatic interruption of a starting maneuver of the motor vehicle can be canceled if the driver of the motor vehicle actuates the accelerator pedal 12 and/or the control element 13.

In the embodiment shown, the monitoring device 15 also features an arithmetic unit 19 and a machine-readable medium 20, wherein a computer program product is stored on the machine-readable medium 20 and, when executed on the arithmetic unit 19, instructs the arithmetic unit 19 to carry out the steps described in connection with the embodiments of the method according to the application, particularly the steps of the method according to FIG. 1 and FIG. 2, by means of the described elements. For this purpose, the arithmetic unit 19 is directly or indirectly connected to the corresponding elements, but these connections are not illustrated in greater detail in the figures.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for monitoring a starting maneuver of a motor vehicle, comprising:
determining whether at least one object is detected by at least one first sensor,
wherein the at least one first sensor is realized in a form of an ultrasonic sensor for detecting objects within a first detection area, and
wherein the first detection area comprises a first sub-area of surroundings of the motor vehicle that lies in a driving direction of the motor vehicle to be monitored;
determining a degree of probability of a collision between the at least one object detected by the at least one first sensor and the motor vehicle in case of the starting maneuver of the motor vehicle if the at least one object is detected by the at least one first sensor; and
at least temporarily interrupting the starting maneuver of the motor vehicle if the degree of probability of the collision exceeds a first predefined threshold value.

2. The method according to claim 1, further comprising generating a warning message if the degree of probability of the collision exceeds the first predefined threshold value.

3. The method according to claim 2, wherein the warning message is an optical warning message.

4. The method according to claim 1, further comprising:
determining whether the at least one object is detected by at least one second sensor of the motor vehicle,
wherein the at least one second sensor is realized in the form of an electromagnetic sensor for detecting objects within a second detection area, and
wherein the second detection area comprises a second sub-area of the surroundings of the motor vehicle that lies in the driving direction of the motor vehicle to be monitored and at least partially differs from the first detection area;
determining the degree of probability of the collision between the at least one object detected by the at least one second sensor and the motor vehicle in case of the starting maneuver of the motor vehicle if the at least one object is detected by the at least one second sensor; and
at least temporarily interrupting the starting maneuver of the motor vehicle if the degree of probability of the collision exceeds a second predefined threshold value.

5. The method according to claim 4, wherein the determining whether the at least one object is detected by the at least one second sensor is performed prior to determining whether the at least one object is detected by the at least one first sensor.

6. The method according to claim 5, wherein it is determined whether the at least one object is detected by the at least one first sensor of the motor vehicle if no object is detected by the at least one second sensor or if the degree of probability of the collision does not exceed the second predefined threshold value.

7. The method according to one of claim 4, wherein the at least one second sensor is a lidar sensor.

8. The method according to claim 1, wherein the at least temporarily interrupting the starting maneuver is configured for cancellation by an occupant of the motor vehicle.

9. The method according to claim 7, wherein the at least temporarily interrupting the starting maneuver is configured for cancellation by actuating an control element of the motor vehicle.

10. The method according to claim 1,
wherein the motor vehicle comprises an adaptive cruise control system, and
wherein the determining whether the at least one object is detected by the at least one first sensor of the motor vehicle is conducted at least after a deceleration of the motor vehicle to a standstill with the adaptive cruise control system.

11. The method according to claim 10, further comprising resuming control of a trailing distance from another motor vehicle that was determined as target vehicle for control of the trailing distance prior to the deceleration after a restarting maneuver.

12. The method according to claim 10, further comprising adjusting a speed of the motor vehicle to a predefined speed with the adaptive cruise control system after a restarting maneuver.

13. A monitoring device for monitoring a starting maneuver of a motor vehicle, comprising:
an ultrasonic sensor configured to detecting objects within a first detection area, the first detection area comprises a first sub-area of surroundings of the motor vehicle that lies in a driving direction of the motor vehicle ;
a first evaluation device configured to determine whether at least one object is detected by the ultrasonic sensor;
a second evaluation device configured to determine a degree of probability of a collision between the at least one object detected by the ultrasonic sensor and the motor vehicle in case of the starting maneuver of the motor vehicle; and
an interrupting device configured to at least temporarily interrupt the starting maneuver of the motor vehicle if the degree of probability of the collision exceeds a first predefined threshold value.

14. A computer readable medium embodying a computer program product, said computer program product comprising:
a monitoring program for monitoring a starting maneuver of a motor vehicle, the monitoring program configured to:
determine whether at least one object is detected by at least one first sensor,
wherein the at least one first sensor is realized in a form of an ultrasonic sensor for detecting objects within a first detection area, and
wherein the first detection area comprises a first sub-area of surroundings of the motor vehicle that lies in a driving direction of the motor vehicle to be monitored;
determine a degree of probability of a collision between the at least one object detected by the at least one first sensor and the motor vehicle in case of the starting maneuver of the motor vehicle if the at least one object is detected by the at least one first sensor; and
at least temporarily interrupt the starting maneuver of the motor vehicle if the degree of probability of the collision exceeds a first predefined threshold value.

15. The computer readable medium embodying the computer program product according to claim 14, the monitoring program further configured to generate a warning message if the degree of probability of the collision exceeds the first predefined threshold value.

16. The computer readable medium embodying the computer program product according to claim 15, wherein the warning message is an optical warning message.

17. The computer readable medium embodying the computer program product according to claim 14, the monitoring program further configured to:
determine whether the at least one object is detected by at least one second sensor of the motor vehicle,
wherein the at least one second sensor is realized in the form of an electromagnetic sensor for detecting objects within a second detection area, and
wherein the second detection area comprises a second sub-area of the surroundings of the motor vehicle that lies in the driving direction of the motor vehicle to be monitored and at least partially differs from the first detection area;
determine the degree of probability of the collision between the at least one object detected by the at least one second sensor and the motor vehicle in case of the starting maneuver of the motor vehicle if the at least one object is detected by the at least one second sensor; and
at least temporarily interrupt the starting maneuver of the motor vehicle if the degree of probability of the collision exceeds a second predefined threshold value.

18. The computer readable medium embodying the computer program product according to claim 17, wherein the monitoring program is configured to determine whether the at least one object is detected by the at least one second sensor prior to determining whether the at least one object is detected by the at least one first sensor.

19. The computer readable medium embodying the computer program product according to claim 18, wherein the monitoring program is configured is determine whether the at least one object is detected by the at least one first sensor of the motor vehicle if no object is detected by the at least one second sensor or if the degree of probability of the collision does not exceed the second predefined threshold value.

20. The computer readable medium embodying the computer program product according to claim 19, wherein the at least one second sensor is a lidar sensor.
